(19) United States
(12) Patent Application Publication
(10) Pub. No.: US 2014/0276623 A1
(43) Pub. Date: Sep. 18, 2014

(54) DEVICES AND METHODS FOR ENTERAL FEEDING

(71) Applicant: Boston Scientific Scimed, Inc., Maple Grove, MN (US)

(72) Inventor: Ralph J. BARRY, JR., Hudson, MA (US)

(73) Assignee: Boston Scientific Scimed, Inc., Maple Grove, MN (US)

(21) Appl. No.: 14/205,943

(22) Filed: Mar. 12, 2014

Related U.S. Application Data
(60) Provisional application No. 61/779,853, filed on Mar. 13, 2013.

(51) Int. Cl. A61J 15/00

(52) U.S. Cl. CPC A61J 15/0049; A61J 15/0015
USPC 604/513; 604/103.06

(57) ABSTRACT

According to one aspect of the disclosure, a medical device may include a dilation device. The dilation device may include an expandable member configured to extend at least partially into an opening in tissue. The expandable member may also be configured to expand the opening when the expandable member moves from an unexpanded state to an expanded state. The dilation device may also include one or more markings on the expandable member. The one or more markings may be configured to provide a visual indication of a characteristic of the opening in the tissue when the expandable member extends at least partially into the opening. The medical device may also include a feeding device configured to extend at least partially into the opening in the tissue. At least a portion of the dilation device may be configured to be received within the feeding device.

### CROSS-REFERENCE TO RELATED APPLICATIONS

This application claims the benefit of priority from U.S. Provisional Application No. 61/779,853, filed on Mar. 13, 2013, the entirety of which is incorporated by reference herein.

### TECHNICAL FIELD

Various embodiments of the present disclosure relate generally to medical devices and related methods. More specifically, embodiments of this disclosure relate to medical devices and related methods for enteral feeding.

### BACKGROUND

A variety of devices have been used to place gastric feeding tubes in patients. Some of these devices may use a series of dilators, and/or a peel away sheath with dilators, to form the opening or stoma through the patient's abdominal and stomach walls. Some devices may be used in conjunction with a separate measuring device to determine proper gastric feeding tube length.

When using a series of dilators to dilate the stoma, an insufflation gas may escape from the patient's stomach as one dilator is removed and another dilator is inserted. Telescopic dilators have been utilized to reduce unwanted escape of insufflation gas. However, telescopic dilators may be too long for the anatomies of certain patients.

Stoma measuring devices come in a variety of designs and materials ranging from a plastic strip that has markings on it identifying length, to a length of tubing that includes a series of markings along the outside of the tubing to measure stoma length. In order to use such stoma measuring devices, a user may have to remove a dilator from the stoma to allow a stoma measuring device to be inserted through the stoma. Thus, inserting and withdrawing the stoma measuring device from the stoma may result in the user performing additional steps, which may be inefficient, and/or could lead to insufflation gas leakage.

In view of the above, the present medical devices and related methods described herein provide improvements in enteral feeding.

### SUMMARY

In accordance with certain embodiments of the present disclosure, a medical device may include a dilation device. The dilation device may include an expandable member configured to extend at least partially into an opening in tissue. The expandable member may also be configured to expand the opening when the expandable member moves from an unexpanded state to an expanded state. The dilation device may also include one or more markings on the expandable member. The one or more markings may be configured to provide a visual indication of a characteristic of the opening in the tissue when the expandable member extends at least partially into the opening. The medical device may also include a feeding device configured to extend at least partially into the opening in the tissue. At least a portion of the dilation device may be configured to be received within the feeding device.

In accordance with certain embodiments of the present disclosure, a medical device may include an adapter including one or more passages. The medical device may also include a shaft. The shaft may include a proximal portion coupled to the adapter. The shaft may also include one or more lumens in fluid communication with the one or more passages of the adapter. The shaft may also include a distal portion. The medical device may also include an expandable member coupled to the distal portion of the shaft, and in fluid communication with the one or more lumens. The expandable member may be configured to extend at least partially into an opening in tissue, and to expand the opening when the expandable member moves from an unexpanded state to an expanded state. A portion of the expandable member may have one or more markings. The one or more markings may be configured to provide a visual indication of a characteristic of the opening when the expandable member extends at least partially into the opening.

In accordance with certain embodiments of the present disclosure a method for placing a feeding device in an opening through tissue of a patient may include inserting at least a portion of an expandable member of a dilation device into the tissue opening. The method may also include expanding the expandable member from an unexpanded state to an expanded state, to expand the tissue opening. The method may also include comparing one or more markings on the expandable member to at least a portion of the tissue opening when the expandable member extends at least partially into the tissue opening, to obtain an indication of a characteristic of the tissue opening. The method may also include selecting a feeding device based at least in part on the indication of the characteristic of the tissue opening. The method may also include inserting at least a portion of a tubular member of the feeding device into the tissue opening.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a side view of parts of an assembly, including a balloon dilation catheter, a sheath, and an enteral feeding device, consistent with embodiments of the present disclosure;

FIG. 2 is a partial cut-away view of portions of the assembly shown in FIG. 1, in use, consistent with embodiments of the present disclosure;

FIG. 3 is a partial cut-away view of portions of the assembly shown in FIG. 1, in use, consistent with embodiments of the present disclosure; and

FIG. 4 is an illustration of the assembly shown in FIG. 1, in use, consistent with embodiments of the present disclosure.

### DESCRIPTION OF THE EMBODIMENTS

Reference will now be made in detail to the exemplary embodiments of the disclosure, examples of which are illustrated in the accompanying drawings. Wherever possible, the same reference numbers will be used throughout the drawings to refer to the same or like parts. The term “distal” refers to the end farthest away from a medical professional when introducing a device in a patient. The term “proximal” refers to the end closest to the medical professional when placing a device in the patient.

In exemplary embodiments of the present disclosure, an enteral feeding device is inserted into a stoma in a patient to provide access into the patient's stomach, allowing nutrients, medication, and/or other treatment materials to be introduced into the interior of the patient's stomach through the enteral feeding device. The enteral feeding device may be emplaced with assistance from a balloon dilation catheter, which may help create the stoma and provide an indication of dimensions of the stoma; and a sheath, to help protect portions of the enteral feeding device when the balloon dilation catheter is received therein. Though this description describes medical devices and related methods for enteral feeding via a patient's stomach, it is also contemplated that embodiments of the present disclosure may be used to place devices in stomas in other parts of a patient's body.

According to one aspect of the present disclosure, an assembly 10, shown in FIG. 1, may include a balloon dilation catheter 12, a sheath 14, and an enteral feeding device 16. The balloon dilation catheter 12 may be received in the sheath 14, and the sheath 14 may be received in the enteral feeding device 16. The balloon dilation catheter 12 may be sized and shaped to be slidable through the sheath 14, and the sheath 14 may be sized and shaped to be slidable through the enteral feeding device 16.

The balloon dilation catheter 12 may include an adapter 18 forming a proximal portion of the balloon dilation catheter 12, a shaft 20, and a balloon 22. The balloon 22 and a portion of the shaft 20 may form a distal portion of the balloon dilation catheter 12.

The adapter 18 may include a hub or a connector, such as a Y-connector 19. The adapter 18 may include a first inlet 24 at or near its proximal end, and a first passage 26 in fluid communication with the first inlet 24. The first inlet 24 and the first passage 26 may be configured to slidably receive a guidewire 30, and also fluids or other material. The adapter 18 may also include a second inlet 32 at or near its proximal end, and a second passage 34 in fluid communication with the second inlet 32. The second inlet 32 and the second passage 34 may be configured to receive a fluid (not shown). For example, the second inlet 32 may be in communication with a catheter fluid pump (not shown) configured to provide fluid flow through the second inlet 32 and second passage 34.

The shaft 20 may be coupled to the adapter 18. At least a portion of the shaft 20 may be flexible. The first passage 26 may continue distally through the shaft 20, and may lead to a first outlet 28 at a distal end of the shaft 20. The first inlet 24, first passage 26, and first outlet 28 may form a pathway, through the balloon dilation catheter 12, for the guidewire 30 as well as fluids or other material. The second passage 34 may also continue distally through the shaft 20, and may lead to a second outlet 36 at a side surface of a distal portion of the shaft 20. The second inlet 32, second passage 34, and second outlet 36 may form a pathway through the balloon dilation catheter 12 for fluid flow.

The balloon 22 may be coupled to a distal portion of the shaft 20. For example, the balloon 22 may extend circumferentially around the distal portion of the shaft 20. The interior of the balloon 22 may communicate with the second outlet 36. The catheter fluid pump may direct fluid through the second inlet 32, second passage 34, and second outlet 36, into the interior of the balloon 22 to inflate the balloon 22 (the inflated state represented by dashed lines in FIG. 1). The catheter fluid pump may also withdraw fluid from the interior of the balloon 22 via the second inlet 32, second passage 34, and second outlet 36, to deflate the balloon 22 (the deflated state represented by solid lines in FIG. 1).

The length of the balloon 22 may be selected based on a patient's anatomy. For example, the balloon 22 may have a length of approximately 2 to 4 cm for infant or pediatric use, or may have a length of approximately 10-12 cm for use with adolescents or adults. The balloon 22 may be made of any suitable material that may be stiff enough to create and/or stretch a stoma. For example, the material for the balloon 22 may be stronger than silicone, like PET, nylon, or Pebax.

It is also contemplated that the balloon 22 may include one or more markings 54. The markings 54 may include a plurality of substantially parallel lines, similar to lines on a ruler. The presence of the markings 54 may allow the balloon 22 to be used for measuring and/or otherwise providing an indication of the length of a stoma 110 (FIGS. 2-4) in a patient. The markings 54 may include, for example printed markings, laser-etchings on the surface of the balloon 22, and/or radiopaque markers visible by fluoroscopy. It is also contemplated that a distal portion of the balloon dilation catheter 12, such as a distal portion of the shaft 20, may include one or more radiopaque markers 56. This may provide a user with a way to identify the location of the distal portion when the balloon dilation catheter 12 is in use in a patient, for steering and positioning purposes, and/or to provide a zero point for measuring a length of the stoma 110 using the markings 54.

The markings 54 may be configured, and the material and/or shape of the balloon selected, so that as the balloon 22 inflates, the distance between the markings is substantially unchanged, so that a reliable length measurement may be obtained. For example, the balloon 22 may be configured to inflate radially outward, without expanding axially.

The sheath 14 may include a proximal opening 58, a distal opening 60, and a passageway 62 connecting the proximal opening 58 and the distal opening 60. When the balloon 22 is in a deflated state, the deflated balloon 22, shaft 20, and adapter 18 may be capable of sliding through the passageway 62. The sheath 14 may be configured to be slidably received in the enteral feeding device 16. The sheath 14 may protect internal areas of the enteral feeding device 16 when the balloon dilation catheter 12 moves within the enteral feeding device 16.

The enteral feeding device 16 may include a bolster 64, a shaft 65, and a securing mechanism 67. The bolster 64 may include a first inlet 66, and a first passage 68 in fluid communication with the first inlet 66. The first inlet 66 and first passage 68 may be configured to receive the sheath 14. When the sheath 14 is absent, the first inlet 66 and first passage 68 may be configured to receive nutrients, medicine, and/or other suitable treatment material, from a supply source (not shown).

The bolster 64 may also include one or more valves. For example, a valve 72 may be a duckbill-type one-way valve 72 positioned in the first passage 68, that may allow material to flow from a proximal side of the valve 72 to a distal side of the valve 72 (downstream flow), but prevent the flow of material from the distal side to the proximal side (upstream flow). The valve 72 may include one or more valve gates or flaps 74 that may be biased toward a closed state. Forces on the upstream side of the valve 72, caused by the presence of treatment material or insertion of the sheath 14 into the bolster 64, may cause the one or more valve gates or flaps 74 to open. It is contemplated that the valve 72 may be positioned in a central portion of the first passage 68, or adjacent the distal end of the bolster 64. The sheath 14 may press the flaps 74 into their open position so that the balloon dilation catheter 12 can slide into and through the first passage 68, and may protect the flaps 74 and other internal surfaces of the enteral feeding device 16 from being damaged by the balloon dilation catheter 12.

The bolster 64 may also include a second inlet 76 adjacent the proximal end of the bolster 64, and a second passage 78 in fluid communication with the second inlet 76. The second inlet 76 and second passage 78 may be configured to receive a fluid (not shown). The second inlet 76 may be in communication with a fluid pump (not shown) configured to produce fluid flow through the second inlet 76 and second passage 78. A valve 82 may be positioned in the second passage 78, for example, near the second inlet 76. The valve 82 may be a one-way check valve configured to allow the pumped fluid to flow through the bolster 64 in a distal direction, while preventing return of the fluid in a proximal direction. It is also contemplated that the first inlet 66 and/or the second inlet 76 of the bolster 64 may include an end cap 83 to close the inlets 66 and 76.

The shaft 65 may be coupled to the bolster 64. The shaft 65 may be substantially rigid, or at least a portion of the shaft 65 may be substantially flexible. The first passage 68 may continue distally through the shaft 65, and may lead to a first outlet 70. The first inlet 66, first passage 68, and first outlet 70 may form a pathway for the sheath 14, as well as fluids or other materials, through the enteral feeding device 16. The second passage 78 may continue through the shaft 65, and may lead to a second outlet 80 at a side surface of a distal portion of the shaft 65. The second inlet 76, second passage 78, and second outlet 80 may form a pathway for fluid to travel through the enteral feeding device 16 to the securing mechanism 67.

The securing mechanism 67 may be coupled to a distal portion of the shaft 65. For example, the securing mechanism 67 may include a balloon 100 extending circumferentially around the distal portion of the shaft 65. The interior of the feeding device balloon 100 may communicate with the second outlet 80. The feeding device fluid pump may direct fluid through the fluid pathway and into the interior of the feeding device balloon 100 to inflate the feeding device balloon 100, thus helping to secure the enteral feeding device 16 in the stoma 110. The feeding device fluid pump may also withdraw fluid from the interior of the feeding device balloon 100 via the fluid pathway, to deflate the feeding device balloon 100, thus making it easier to remove the enteral feeding device 16 from the stoma 110. The balloon 100 may be made of any suitable material including, for example, silicone, and may be capable of returning to its non-inflated size when deflated.

The process of emplacing the enteral feeding device 16 in a patient may include inserting a nasogastric tube (not shown) through the patient's nose and into the patient's stomach 102 (FIGS. 2-4) through the esophagus. The nasogastric tube may be connected to a fluid pump (not shown). The fluid pump may be used to inflate the stomach 102. Once the stomach 102 is inflated, a user may mark or otherwise identify one or more locations for inserting one or more gastropexy devices 104. The gastropexy devices 104 may be inserted through the patient's abdominal wall 106 and stomach wall 108, and may be manipulated by the user to adhere the stomach wall 108 to the abdominal wall 106 (FIGS. 2-4).

At the desired location for the enteral feeding device 16, the user may insert an introducer needle (not shown) through the abdominal wall 106 and the stomach wall 108. Insertion of the introducer needle may create an opening 109 through the walls 106 and 108, which, when expanded, will become a stoma 110 for the enteral feeding device 16.

Next, the guidewire 30 may be inserted through the introducer needle and through the walls 106 and 108. The introducer needle may then be removed by sliding it proximally along the guidewire 30. A dilator (not shown) may be slid down into the opening 109, along the guidewire 30, to expand the opening 109 to a size where the balloon dilation catheter 12 may be inserted into the opening 109. Once the opening 109 has been enlarged sufficiently, the dilator may be removed.

The balloon dilation catheter 12 may be introduced over the guidewire 30, and may be slid distally along the guidewire 30 to the opening 109. The sliding may continue until the distal portion of the balloon dilation catheter 12 is positioned within the opening (FIG. 2). The balloon 22 may be deflated during positioning within the opening 109 to make insertion and positioning easier. Once positioned within the opening 109, the balloon 22 may be inflated, enlarging the opening 109 and creating the stoma 110. Proper positioning of the balloon 22 in the opening 109 may be achieved by visualizing the radiopaque marker 56 at the distal tip of the balloon dilation catheter 12 using fluoroscopy, to ensure the distal tip has reached an interior side of the opening 109.

The balloon dilation catheter 12 may be moved to a position where the marker 56 is positioned at or adjacent an interior surface of the stomach wall 108. Markings 54 on the balloon 22 may be viewed with the naked eye and/or fluoroscopy, to measure a depth of the stoma 110. Once the depth is determined, the user may select the enteral feeding device 16 having suitable dimensions for the stoma 110.

The enteral feeding device 16 may be prepared for insertion into the stoma 110 by sliding the sheath 14 into the first passage 68 via the first inlet 66 of the enteral feeding device 16. As the sheath 14 is inserted, the sheath 14 may force the valve 72 into the open position. The sheath 14 may be inserted until a distal portion of the sheath 14 is distal of the valve 72. It is also contemplated that the sheath 14 may be inserted until a distal portion of the sheath 14 reaches the first outlet 70 of the enteral feeding device 16, or extends distally out of the first outlet 70.

The combined sheath 14 and enteral feeding device 16 may be introduced over the guidewire 30, and may be moved distally along the guidewire 30 toward the stoma 110. Along the way, the distal opening 60 of the sheath 14 may receive a proximal portion of the balloon dilation catheter 12, and the combined sheath 14 and enteral feeding device 16 may be slid over the balloon dilation catheter 12. The sheath 14 may hold the flaps 74 of the valve 72 open to allow such movement, while protecting the flaps 74 and other internal areas of the enteral feeding device 16 from being damaged by such movement. The user may continue to slide the combined sheath 14 and enteral feeding device 16 until a distal portion of the combined sheath 14 and enteral feeding device 16 is positioned in the stoma 110 (FIG. 4).

To assist positioning of the sheath 14 and enteral feeding device 16 in the stoma 110, the balloon 22 may be deflated, reducing the likelihood of the balloon 22 obstructing movement of the sheath 14 and/or the enteral feeding device 16 over the balloon 22 and into the stoma 110. Certain hidden lines and reference numbers have been omitted from FIG. 4 for the sake of clarity.

With one hand holding the bolster 64 to keep the enteral feeding device 16 in place, and another hand grasping at least one of the balloon dilation catheter 12, guidewire 30, and sheath 14, the user may withdraw the balloon dilation catheter 12, guidewire 30, and sheath 14 from the first passage 68 of the enteral feeding device 16, while leaving the enteral feeding device 16 in place within the stoma 110. The balloon 22 may be in a deflated state to make it easier to withdraw proximally through the enteral feeding device 16 (FIG. 4). It is contemplated that the balloon dilation catheter 12, guidewire 30, and sheath 14 may be removed substantially simultaneously, or in any suitable order. It is also contemplated that the sheath 14 may be removed after the balloon dilation catheter 12 and the guidewire 30, so that the sheath 14 may protect the flaps 74 and other internal areas of the enteral feeding device 16 as the balloon dilation catheter 12 and the guidewire 30 are removed.

The user may then inflate the feeding device balloon 100 to secure the enteral feeding device 16 within the stoma 110. With the enteral feeding device 16 in place, nutrients, medicine, and the like may be introduced into the patient's stomach interior through the enteral feeding device 16.

Other embodiments of the present disclosure will be apparent to those skilled in the art from consideration of the specification and practice of the embodiments disclosed herein. It is intended that the specification and examples be considered as exemplary only, with a true scope and spirit of the present disclosure being indicated by the following claims.

What is claimed is:

1. A medical device, comprising:
a dilation device, including:
an expandable member configured to extend at least partially into an opening in tissue, and to expand the opening when the expandable member moves from an unexpanded state to an expanded state, and
one or more markings on the expandable member, the one or more markings being configured to provide a visual indication of a characteristic of the opening in the tissue when the expandable member extends at least partially into the opening; and
a feeding device configured to extend at least partially into the opening in the tissue, wherein at least a portion of the dilation device is configured to be received within the feeding device.

2. The medical device of claim 1, wherein the expandable member includes a balloon, and the dilation device includes a shaft, the balloon being coupled to the shaft.

3. The medical device of claim 2, wherein the balloon is elongated and surrounds a distal portion of the shaft.

4. The medical device of claim 3, wherein a space between adjacent markings on the expandable member does not change as the balloon moves from the unexpanded state to the expanded state.

5. The medical device of claim 1, wherein the one or more markings includes at least one of printed material, an etching, and a radiopaque material.

6. The medical device of claim 1, wherein the one or more markings are on a surface of the expandable member.

7. The medical device of claim 1, further including a sheath, wherein at least a portion of the sheath is configured to be received within and move relative to the feeding device.

8. The medical device of claim 7, wherein at least a portion of the dilation device is configured to be received within and move relative to the sheath.

9. A medical device, comprising:
an adapter including one or more passages;
a shaft, including:
a proximal portion coupled to the adapter,
one or more lumens in fluid communication with the one or more passages of the adapter, and
a distal portion; and
an expandable member coupled to the distal portion of the shaft, and in fluid communication with the one or more lumens, the expandable member configured to extend at least partially into an opening in tissue, and to expand the opening when the expandable member moves from an unexpanded state to an expanded state, a portion of the expandable member having one or more markings, the one or more markings being configured to provide a visual indication of a characteristic of the opening when the expandable member extends at least partially into the opening.

10. The medical device of claim 9, wherein the expandable member includes an elongated balloon surrounding the distal portion of the shaft, the unexpanded state is a deflated state of the balloon, and the expanded state is an inflated state of the balloon.

11. The medical device of claim 10, wherein the one or more lumens of the shaft includes an inflation lumen configured to deliver fluid to inflate the balloon, and a guidewire lumen.

12. The medical device of claim 9, wherein a space between adjacent markings on the expandable member does not change as the expandable member moves from the unexpanded state to the expanded state.

13. The medical device of claim 9, wherein the one or more markings includes at least one of printed material, an etching, and radiopaque material.

14. The medical device of claim 13, wherein the one or more markings includes a plurality of substantially parallel lines.

15. The medical device of claim 13, further including a radiopaque element distal to the one or more markings.

16. The medical device of claim 9, wherein the adapter includes one or more ports in fluid communication with the one or more passages.

17. A method for placing a feeding device in an opening through tissue of a patient, the method comprising:
inserting at least a portion of an expandable member of a dilation device into the tissue opening;
expanding the expandable member from an unexpanded state to an expanded state, to expand the tissue opening;
comparing one or more markings on the expandable member to at least a portion of the tissue opening when the expandable member extends at least partially into the tissue opening, to obtain an indication of a characteristic of the tissue opening;
selecting a feeding device based at least in part on the indication of the characteristic of the tissue opening; and
inserting at least a portion of a tubular member of the feeding device into the tissue opening.

18. The method of claim 17, wherein expanding the expandable member from the unexpanded state to the expanded state includes inflating a balloon from a deflated state to an inflated state.

19. The method of claim 18, wherein inserting at least a portion of the tubular member into the tissue opening includes deflating the balloon, sliding a sheath into the tubular member, and sliding the tubular member and sheath over the balloon and into the tissue opening.

20. The method of claim 17, wherein obtaining the indication of the characteristic includes obtaining a measurement of a length of the tissue opening.
